(19) United States
(12) Patent Application Publication
(10) Pub. No.: US 2025/0178463 A1
(43) Pub. Date: Jun. 5, 2025

(54) VEHICLE CHARGING SYSTEMS AND METHODS FOR USING SAME

(71) Applicant: Volley Automation, Inc., Denver, CO (US)

(72) Inventor: Jos Christopher Goble, Milpitas, CA (US)

(73) Assignee: Volley Automation, Inc., Denver, CO (US)

(21) Appl. No.: 18/528,104

(22) Filed: Dec. 4, 2023

(51) Int. Cl. B60L 53/16; B60L 53/18; B60L 53/30

(52) U.S. Cl. CPC B60L 53/16; B60L 53/18; B60L 53/30

(57) ABSTRACT

A charging system includes an end effector and a receiver. The end effector includes an end effector housing and a plunger coupled to the end effector housing movable between a retracted position and an extended position. The receiver includes a receiver housing, a cover, a locking member and a spring. The receiver housing defines a receiving cavity. The cover is positioned within the receiving cavity and is movable between a biased position and an unbiased position. A detent is formed in a side wall of the cover. The locking member includes a key and a locking element. The key has an inner surface facing the cover and a recess formed in the inner surface. The key is movable between a locking position and an unlocking position. The locking element is movable radially between the detent formed in the cover and the recess formed in the key.

### TECHNICAL FIELD

The present specification generally relates to charging systems and, more specifically, charging systems for electric vehicles.

### BACKGROUND

Electric vehicles gain significant traction as a more sustainable and environmentally friendly mode of transportation. As adoption of electric vehicles continues, demand for efficient and safe charging solutions is critical. A key aspect of ensuring the safety of electric vehicles is ensuring the safety of electric vehicle charging by mitigating risks associated with electrical hazards for the users and the vehicles.

Automated parking systems may be used to automatically park a vehicle in a parking structure. The automated parking systems may transport vehicles to various spots in the parking structure. Additionally, a user may desire to charge their vehicle while parked in the parking structure. However, various charging port locations on different vehicles make it difficult to automate vehicle charging when the vehicles are parked in the parking structure. Different charging port locations in addition to high voltages cause safety risk when charging electric vehicles.

Accordingly, a need exists for alternative charging systems for electric vehicle charging in automated parking solutions that allow for layers of safety by preventing a user from being able to touch live electrical contacts of the charging system without restricting the mating of a connector.

### SUMMARY

In one embodiment, an end effector includes an end effector housing, an electromagnet, and a plunger. The end effector housing includes a proximal end and distal end opposite the proximal end. A plunger opening is formed in the distal end. The electromagnet is fixed to the end effector housing and is provided at the opening of the distal end of the end effector housing. The electromagnet is operable between an active state and an inactive state. The plunger is coupled to the end effector housing and is movable through the opening between a retracted position and an extended position relative to the end effector housing. A plunger electrical contract is provided on an outer surface of the plunger.

In another embodiment, a receiver includes a receiver housing, a cover, a locking member, a receiver electrical contact, and a spring. The receiver housing includes a radial wall defining a receiving cavity. A receiver opening is formed in the receiver housing. The cover is positioned within the receiving cavity and is movable between a biased position and an unbiased position. A detent is formed in a side wall of the cover. A locking member is positioned between the radial wall and the side wall of the cover. The locking member includes a key and a locking element. The key has an inner surface facing the cover and a recess formed in the inner surface. The key is movable between a locking position and an unlocking position. The locking element is movable radially between the detent formed in the cover and the recess formed in the key. The receiving electrical contact is provided within the receiving cavity. The spring is positioned within the receiving cavity and is configured to bias the cover towards the biased position.

In yet another embodiment, a charging system includes an end effector and a receiver. The end effector includes an end effector housing and a plunger. The plunger is coupled to the end effector housing and is movable between a retracted position and an extended position relative to the end effector housing. The receiver includes a receiver housing, a cover, a locking member and a spring. The receiver housing defines a receiving cavity. The cover is positioned within the receiving cavity and is movable between a biased position and an unbiased position. A detent is formed in a side wall of the cover. The locking member is positioned within the receiving cavity and includes a key and a locking element. The key has an inner surface facing the cover and a recess formed in the inner surface. The key is movable between a locking position and a unlocking position. The locking element is movable radially between the detent formed in the cover and the recess formed in the key. The spring is position within the receiving cavity and is configured to bias the cover towards the biased position.

These and additional features provided by the embodiments described herein will be more fully understood in view of the following detailed description, in conjunction with the drawings.

### BRIEF DESCRIPTION OF THE DRAWINGS

The embodiments set forth in the drawings are illustrative and exemplary in nature and not intended to limit the subject matter defined by the claims. The following detailed description of the illustrative embodiments can be understood when read in conjunction with the following drawings, where like structure is indicated with like reference numerals and in which:

FIG. 1 schematically depicts a partial perspective view of a vehicle charging system communicating with a vehicle, according to one or more embodiments shown and described herein;

FIG. 2 schematically depicts a side view of an end effector of the vehicle charging system, according to one or more embodiments shown and described herein;

FIG. 3 schematically depicts a side view of a receiver of a vehicle charging system, according to one or more embodiments shown and described herein;

FIG. 4 schematically depicts a side view of the vehicle charging system with the receiver in a locked state and the end effector in a disengaged position, according to one or more embodiments shown and described herein;

FIG. 5 schematically depicts a side view of the vehicle charging system with the receiver in the locked state and the end effector in a mated position, according to one or more embodiments shown and described herein;

FIG. 6 schematically depicts a side view of the vehicle charging system with the receiver in an unlocked state and the end effector in a secured position, according to one or more embodiments shown and described herein;

FIG. 7 schematically depicts a side view of the vehicle charging system, with the receiver in the unlocked state and the end effector in an inserted position, according to one or more embodiments shown and described herein;

FIG. 8 schematically depicts a side view of the vehicle charging system, with the receiver in the locked state and the end effector in an ejected position, according to one or more embodiments shown and described herein;

FIG. 9 depicts a control system for operating the vehicle charging system, according to one or more embodiments shown and described herein; and

FIG. 10 schematically depicts a flowchart for a method of operating the vehicle charging system, according to one or more embodiments shown and described herein.

### DETAILED DESCRIPTION

Embodiments described herein are generally directed to vehicle charging systems for charging an electric vehicle. The vehicle charging systems include mechanisms for the protection of both the system and users of the system. In particular, embodiments of the vehicle charging systems include a cover positionable between a biased position and an unbiased position to prevent an individual from accessing live electrical contacts during the operation of the vehicle charging system. Embodiments of the vehicle charging system also include a locking member configured to cause the end effector to rapidly eject in an emergency condition.

The vehicle charging system may be used in conjunction with an automated parking system for automatically parking vehicles within a parking structure. The automated parking system may use a lift that picks up and transports the vehicle to a parking space in the parking structure. A driver can insert an adapter into a charging port of the vehicle before the vehicle is transported to the parking structure. Once the vehicle is automatically parked in the parking structure by the automatic parking system, an end effector coupled to a charging cable may be inserted into the receiver to delivery current to the charging port of the vehicle and begin charging the vehicle.

As described in greater detail below, the charging system includes an end effector, a receiver, and an electromagnet. The electromagnet is operable to couple the end effector to the receiver. The end effector includes an end effector housing, a plunger opening formed in the distal end of the end effector housing. A plunger is coupled to the end effector housing and is movable through the opening between a retracted position and an extended position. Plunger electrical contacts are provided on an outer surface of the plunger. The receiver includes a receiver housing having a radial wall defining a cavity. A cover is positioned within the receiving cavity and is movable between a biased position and an unbiased position. The cover includes a detent formed in a side wall. A locking member is positioned between the radial wall and the side wall of the cover. The locking member comprises a key with an inner surface facing the cover having a recess formed in the inner surface, and a locking element that is movable radially between the detent formed in the cover and the recess formed in the key. The key is movable between a locking position and an unlocking position. The receiver includes receiving electrical contacts provided within the receiving cavity that correspond to the plunger electrical contacts and operate to charge the electric vehicle. A spring is positioned within the receiving cavity and is configured to bias the cover towards the biased position.

Various embodiments of the vehicle charging system and the operation of the vehicle charging system will be described in more detail herein. Whenever possible, the same reference numerals will be used throughout the drawings to refer to the same or like parts.

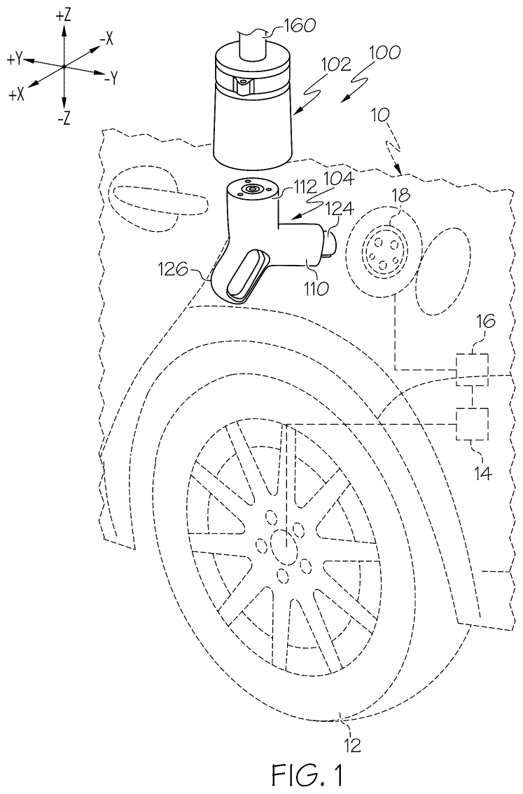

As used herein, the term “longitudinal direction” refers to the forward-rearward direction of the vehicle (i.e., in the +/−Y-direction depicted in FIG. 1). The term “lateral direction” refers to the cross-vehicle direction (i.e., in the +/−X-direction depicted in FIG. 1), and is transverse to the longitudinal direction. The term “vertical direction” or “above” or “below” refer to the upward-downward direction of the vehicle (i.e., in the +/−Z-direction depicted in FIG. 1).

Referring now to FIGS. 1-3, a vehicle charging system 100 for an electric vehicle 10 is depicted. The electric vehicle 10 may include one or more wheels 12, one or more motors 14 operatively coupled to the one or more wheels 12 to drive the wheels 12, a battery 16 operatively coupled to the motors 14 to provide current to the motors 14, and a charging port 18 operatively coupled to the battery 16 to transfer current to the battery 16. While FIG. 1 depicts the electric vehicle 10 as a passenger vehicle, such as a car or SUV, it is contemplated and possible that the electric vehicle 10 is any vehicle having a battery 16 that supplies current to motors that assist in driving the wheels 12 of the vehicle 10, such as, for example, a hybrid vehicle. The charging port 18 may be any traditional charging port for transferring current from an electric vehicle charger or charging station to the battery 16 of the electric vehicle 10. For example, the charging port 18 may be a type 1 or type 2 AC connector type charging port. Alternatively, the charging port 18 may be a DC type charging port. In other embodiments, the charging port 18 may include a combination of AC and DC charging port components to allow for simultaneous AC and DC charging.

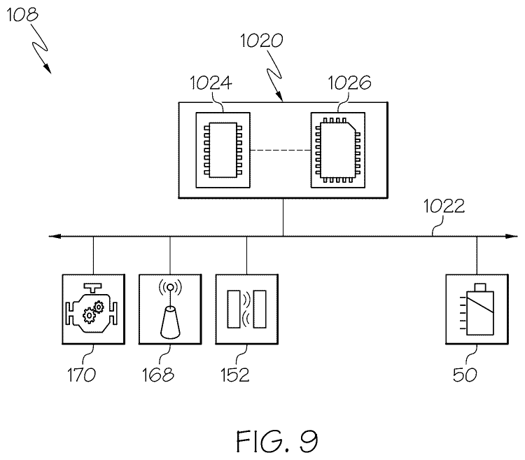

The vehicle charging system 100 may include an end effector 102, an adapter 104 including a receiver 112, and a control system 108 (FIG. 9). The adapter 104 may include a connector 110 configured to engage with the charging port 18 of the electric vehicle 10. The connector 110 may be a traditional charging connector for an electric vehicle 10, such as, for example, an SAE J1772 connector. The connector 110 may include a charging portion 124 configured to engage the charging port 18 of the electric vehicle 10, and a handle 126 extending from the charging portion 124. The charging portion 124 may include a plurality of charging pins (not shown) configured to transfer current to the charging port 18 when the connector 110 engages the charging port 18.

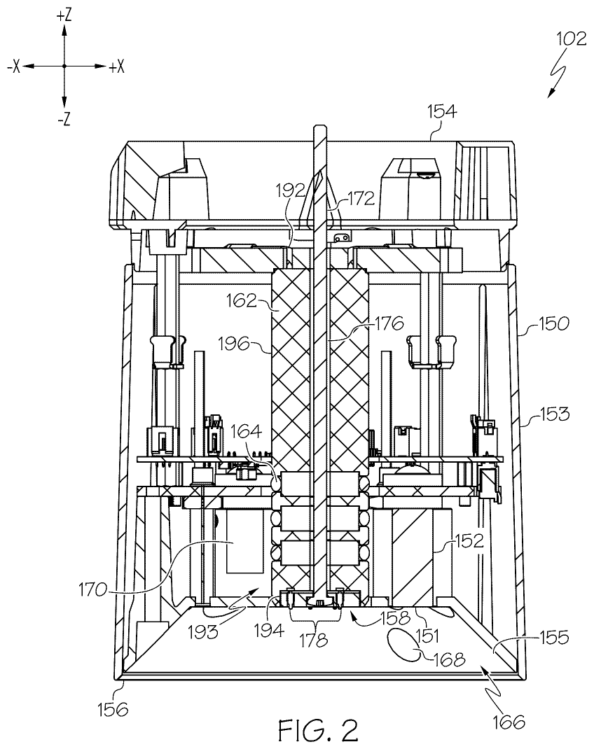

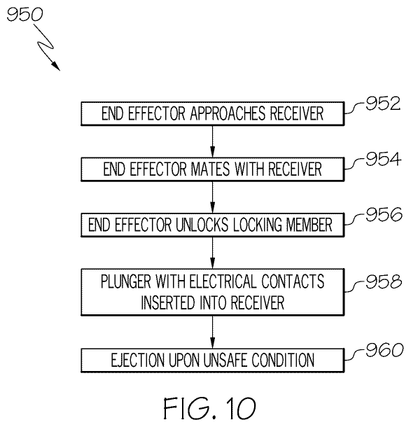

As depicted in FIG. 2, in embodiments, the end effector 102 includes an end effector housing 150, one or more electromagnets 152, a plunger 162, one or more plunger electrical contacts 164, a locating member 166, and one or more motors 170. In embodiments, a charging cable 160 (FIG. 1) extends from the end effector 102 to connect to a charging station 50 (FIG. 10), not shown. The end effector housing 150 includes a proximal end 154 and a distal end 156 opposite the proximal end 154. In embodiments, the end effector housing 150 further comprises an outer surface 153 and an inner surface 155 that extends from the outer surface 153 at the distal end 156. In embodiments, the inner surface 155 tapers toward the proximal end 154 of the end effector housing 150 in the direction towards the plunger opening 158. A plunger opening 158 is formed within the inner surface 155 of the end effector housing 150.

In embodiments, one or more electromagnets 152 are fixed to the end effector housing 150. The electromagnet 152 includes a receiver facing surface 151. In embodiments, the electromagnet 152 is provided at the plunger opening 158 of the end effector housing 150. However, it should be understood that the electromagnet 152 may be provided at any location on either the end effector 102 or the receiver 112 to couple the end effector 102 to the receiver 112, as described in further detail below. Further, any number of electromagnets 152 may be fixed to the end effector housing 150. In embodiments, a plurality of electromagnets 152 are spaced apart and arranged circumferentially about the plunger 162. In embodiments, the receiver facing surface 151 of the electromagnets 152 may be flush with the plunger opening 158 of the end effector housing 150. The electromagnets 152 function as a locking mechanism to lock the end effector 102 to the receiver 112. However, it should be appreciated that other suitable locking mechanisms may be provided such as, for example, manual clips, automated and retractable locking pins, ordinary magnets, and the like.

In embodiments, the end effector 102 further includes a sensor 168 configured to detect a position of the end effector 102 relative to the receiver 112 and sends instruction to a controller 1020, as shown in FIG. 9 and described in more detail herein, which activates the electromagnet 152 from an inactive state to an active state. In the inactive state, the electromagnet 152 is not magnetized. In the active state, the electromagnet 152 is magnetized and operable to couple the end effector 102 to the receiver 112, as described below. In embodiments, the sensor 168 may be an inductive proximity sensor, a motion sensor, a touch sensor, a light sensor, a switch, or any other suitable device configured to detect a position of the end effector 102 relative to the receiver 112.

The plunger 162 is positionable within the end effector housing 150 and includes a first end 192, a second end 194 opposite the first end 192, and an outer surface 196. A screw 176 is positioned radially within the plunger 162 to secure various separable portions of the plunger 162 together. The second end 194 extends towards the distal end 156 of the end effector housing 150. The plunger 162 is operable such that the second end 194 extends through the plunger opening 158 of the end effector housing 150 to be in an extended position. In the extended position, an extended portion 193 of the plunger 162 is positioned outside of the end effector housing 150. In embodiments, the one or more motors 170 facilitates movement of the plunger 162 toward the extended position. More specifically, upon rotation of the one or more motors 170, the plunger 162 moves vertically from a retracted position toward the extended position. However, it should be appreciated that the plunger 162 may be moved from the retracted position to the extended position in any suitable manner.

As described herein, the plunger 162 may be operatively coupled to the charging cable 160 (FIG. 1) to receive electrical current from an external power source such as, for example, a charging station 50. The one or more plunger electrical contacts 164 may be provided on the extended portion 193 of the plunger 162, such as positioned along the outer surface 196. The plunger electrical contacts 164 may be spaced apart from one another along the extended portion 193 between the first end 192 and the second end 194. Each of the plunger electrical contacts 164 may be arranged such that the plunger electrical contact 164 is ring-shaped and extends along the outer surface 196 to circumferentially surround the screw 176. In embodiments, the plunger electrical contacts 164 may be canted coils. However, it is contemplated that the plunger electrical contacts 164 may be any other traditional electrical contact that is positionable around the screw 176 and capable of transferring current. In embodiments, the screw 176 extends radially within the plunger 162 and electrical contacts 178 are provided proximate a distal end of the screw 176.

The plunger electrical contacts 164 may be electrically connected to the charging cable 160 (FIG. 1) so that the current from the external power source may be transferred to the plunger electrical contacts 164. The plunger electrical contacts 164 may be formed of any material capable of transferring current.

The locating member 166 may be defined by the inner surface 155 that extends from the outer surface 153. As discussed herein, the inner surface 155 tapers toward the proximal end 154 of the end effector housing 150. Due to the tapered nature of the inner surface 155, the locating member 166 has a conical shape configured to accommodate for misalignment between the end effector 102 and the receiver 112 as the end effector 102 is brought into contact with the receiver 112. In other embodiments, the locating member 166 may include one or more fingers that extend obliquely from the periphery of the distal end 156 of the end effector housing 150. The fingers may extend at an angle and a distance such that the fingers extend around the outer surface 153 of the receiver 112. The locating member 166 may act as a counterweight to orient the screw 176 when the end effector 102 contacts the receiver 112.

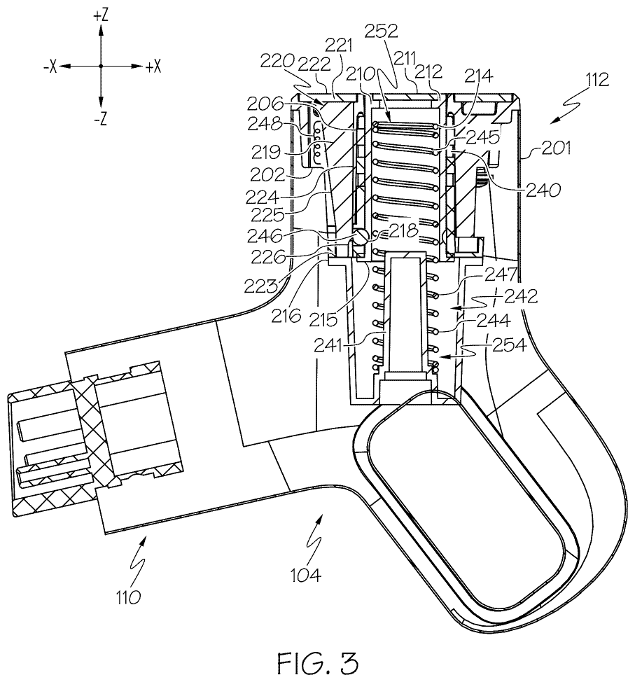

Referring now to FIG. 3, the receiver 112 includes a receiver housing 201, a cover 210, a locking member 220, one or more receiving electrical contacts 240 and a spring 244. The receiver housing 201 includes a radial wall 202 that defines a receiving cavity 242. In embodiments, the receiving cavity 242 includes a first receiving cavity portion 252 and a second receiving cavity portion 254. The second receiving cavity portion 254 has a reduced diameter relative to the first receiving cavity portion 252 to define a step 216 in the radial wall 202. In embodiments, a protruding wall 241 is positioned radially within the second receiving cavity portion 254 of the receiving cavity 242. In embodiments, the receiving electrical contracts are location on an inner radial wall 206, as described below. However, it should be understood that the receiving electrical contacts 240 may be located at any location within the receiving cavity 242.

The cover 210 is positioned within the receiving cavity 242. In embodiments, the cover 210 is positioned within the first receiving cavity portion 252. In some embodiments, the receiver housing 201 further includes an inner radial wall 206. In such embodiments, the cover 210 is positioned radially within the inner radial wall 206. The cover 210 may be generally tubular in shape and defined by a side wall 214. Proximal to the side wall 214 is a lip 212 extending in an inward direction. In embodiments, a plate 211 may be placed on the lip 212 of the cover 210. The plate 211 is configured to prevent physical contact with the receiver electrical contacts 240. Opposite the lip 212 on the side wall 214 of the cover 210 is a catch 215. The catch 215 is configured to abut the inner radial wall 206 in order to prevent the cover 210 from exiting the receiving cavity 242. A detent 218 is formed in the side wall 214 of the cover 210. The detent 218 is sized and shaped as to fit the locking element 246, as described in more detail below. The cover 210 is movable between a biased position and an unbiased position. In the biased position, the cover 210 is positioned within the first receiving cavity portion 252. In the unbiased position, the cover 210 is positioned within the second receiving cavity portion 254.

The locking member 220 is positioned between the radial wall 202 and the side wall 214 of the cover 210. In embodiments, the locking member 220 is positioned between the radial wall 202 and the inner radial wall 206. The locking member 220 includes a key 219 having an inner surface 224 and an opposite outside surface 225. The key 219 includes an upper surface 221 and an opposite lower surface 223. The inner surface 224 includes a recess 226 configured to partially receive the locking element 246. As shown, the recess 226 is formed at the lower surface 223 of the key 219. However, the recess 226 may be formed at any location suitable location of the key 219.

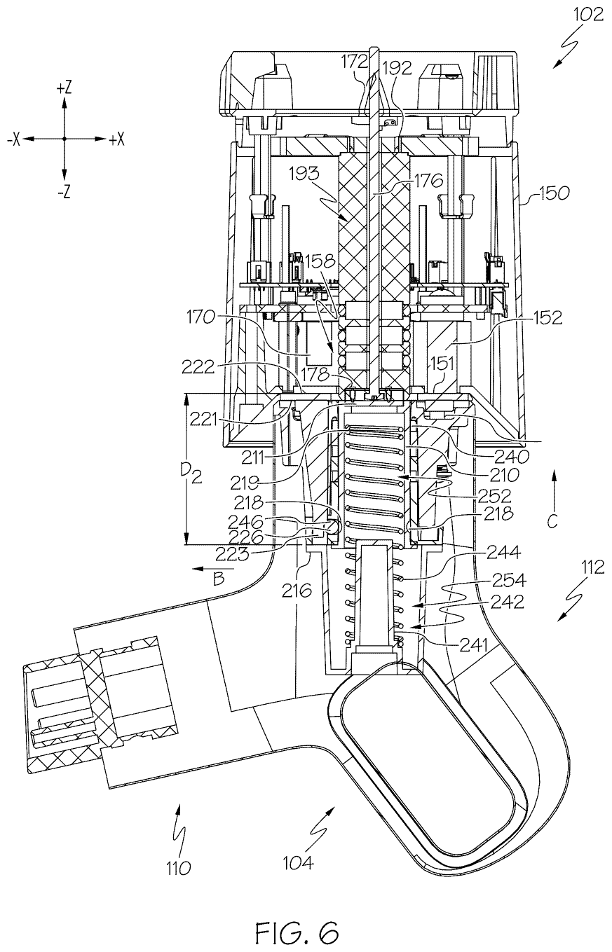

The key 219 of the locking member 220 may be made of a material as to engage with the electromagnet 152 of the end effector 102. In embodiments the upper surface 221 of the key 219 engages with the receiver facing surface 151 of the electromagnet 152. In other embodiments, a strike plate 222 may be coupled to the upper surface 221 of the key 219. In such embodiments, the strike plate 222 is configured to engage with the receiver facing surface 151 of the electromagnet 152 (FIG. 2). In embodiments, the key 219 or the strike plate 222 may be comprised of a ferrous material. The key 219 is movable between a locking position, as shown in FIG. 3, and an unlocking position, as shown in FIG. 6. In embodiments, a biasing member 248 biases the key 219 into the locking position. In embodiments, the biasing member 248 may be a biasing member 248 for biasing the key 219 towards the locking position from the unlocking position.

In embodiments, the locking element 246 is a ball bearing. The locking element 246 is movable radially between the detent 218 in the cover 210 and the recess 226 formed in the key 219. In embodiments, the locking member 220 includes a plurality of keys 219 and a plurality of locking elements 246 spaced apart and arranged circumferentially about the cover 210. In embodiments, the locking member 220 includes three keys 219 with each key 219 having an associated detent 218 formed therein for receiving a respective locking element 246.

The receiver 112 includes a spring 244 that is positioned within the receiving cavity 242 of the receiver housing 201. The spring 244 is configured to bias the cover 210 towards the biased position wherein the cover 210 is positioned within the first receiving cavity portion 252. The spring 244 extends through both the first receiving cavity portion 252 and the second receiving cavity portion 254 in the biased position. The spring 244 includes a top portion 245 that is positioned radially inside of the cover 210 and a lower portion 247 positioned to surround the protruding wall 241 within the second receiving cavity portion 254.

The one or more receiver electrical contacts 240 may be provided on the inner radial wall 206 within the receiving cavity 242 and coupled thereto. In embodiments, the receiver electrical contacts 240 may be canted coils. However, it is contemplated that the receiver electrical contacts 240 may be any other traditional electrical contact positionable within the receiving cavity 242 and capable of transferring current. The one or more receiver electrical contacts 240 may be electrically connected to the charging pins of the connector 110 via an electrical conduit that transfers current from the receiver electrical contacts 240 to the charging pins.

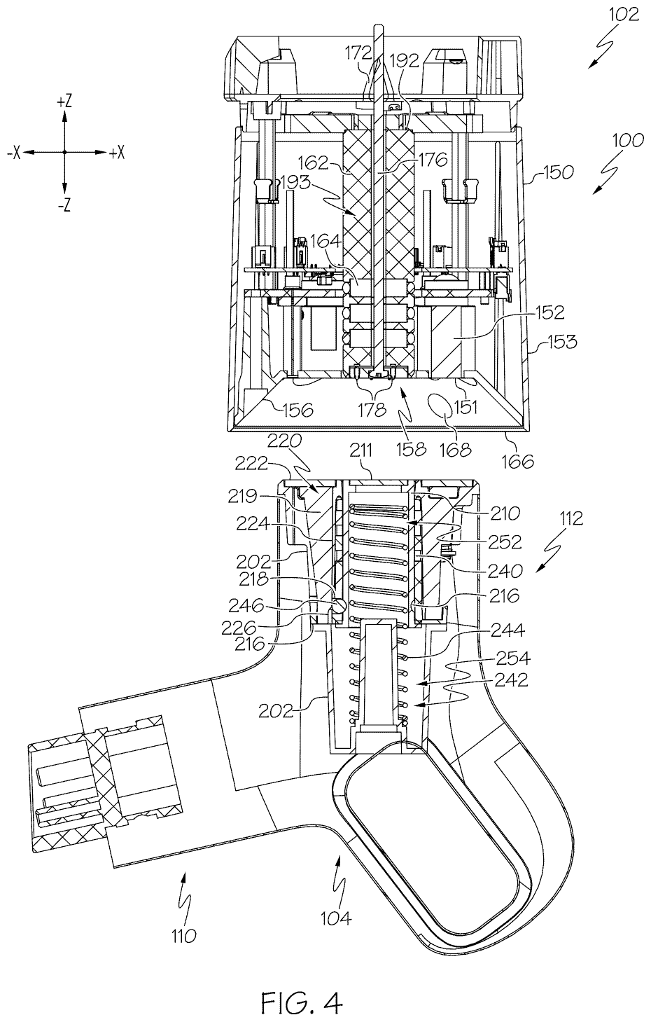

Referring now to FIG. 4, the vehicle charging system 100 of FIG. 1, with the receiver 112 in the locked state and the end effector 102 in the disengaged position, is depicted. In the disengaged position, the end effector 102 and the receiver 112 are not engaged, i.e., in contact, with one another. Additionally, the electromagnets 152 are in the inactive state and not magnetized. The plunger 162 is positioned in the retracted position such that the extended portion 193 is positioned within the end effector housing 150.

In the locked state and disengaged position, the key 219 of the locking member 220 is in the secured position wherein the lower surface 223 of the key 219 abuts against the step 216 of the radial wall 202. The locking element 246 is positioned within the detent 218 in the side wall 214 of the cover 210. The cover 210 is in the biased position such that the spring 244 biases the cover 210 within the first receiving cavity portion 252 of the receiver 112. The locking element 246 prevents the cover 210 from moving towards the unbiased position. For example, if a force is applied, such as by an individual's finger, in a downward direction on the cover 210, the cover 210 will remain held in the biased position. As such, access to the receiver electrical contracts 240 is prevented to reduce risk of injury to an individual.

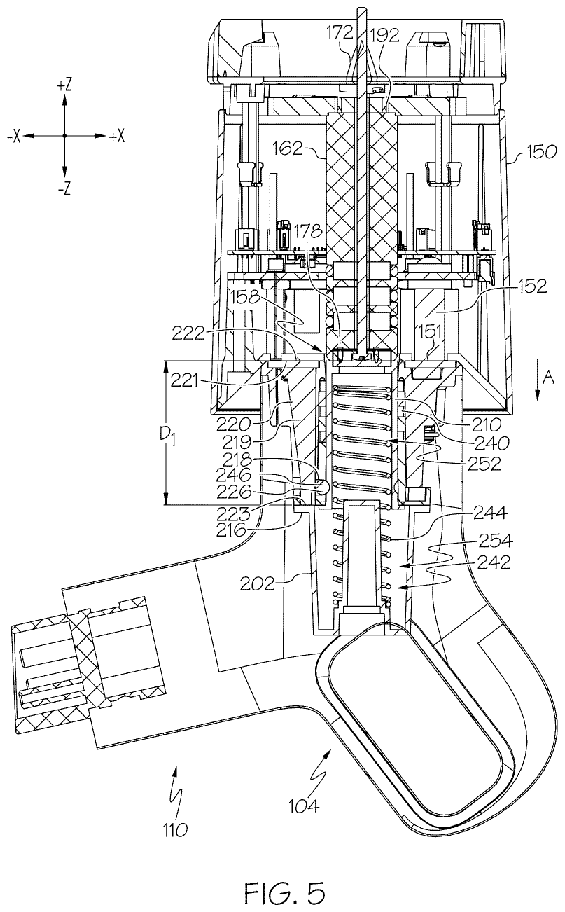

Referring now to FIG. 5, the vehicle charging system 100 in the locked state and mated position is depicted. As stated above, in the locked state, the key 219 of the locking member 220 is in the locking position wherein the lower surface 223 of the key 219 abuts against the step 216 of the radial wall 202. The locking element 246 is positioned within the detent 218 in the side wall 214 of the cover 210. The cover 210 is in the biased position such that the spring 244 biases the cover 210 within the first receiving cavity portion 252 of the receiver 112. The locking element 246 prevents the cover 210 from moving towards the unbiased position.

In the mated positon, the end effector 102 has moved to couple with the receiver 112 in the direction of arrow A. The electromagnets 152 are activated and are engaged with upper surface 221 of the key 219 of the locking member 220. In some embodiments, the electromagnets 152 are engaged with the strike plate 222 coupled to the key 219. The lower surface 223 of the key 219 abuts against the step 216 of the radial wall 202. The locating member 166 extends over the receiver 112. Upon engagement of the electromagnets 152 with the key 219, the plunger 162 moves in the direction of arrow A, as described below. The upper surface 221 of the key and the step 216 of the radial wall 202 are spaced apart from one another by a first distance D1.

Referring now to FIG. 6, the vehicle charging system 100 in the unlocked state and secured position is depicted. In the secured position, the end effector 102 is coupled to the receiver 112 via the electromagnets 152 and the key 219. The one or more motors 170 are activated and the plunger 162 is positioned within the end effector housing 150. In embodiments, the one or more motors 170 includes a plurality of individual motors that cooperate with one another to position the plunger 162.

In the unlocked state, the key 219 is moved in the direction of arrow C such that the lower surface 223 of the key 219 no longer abuts the step 216 of the radial wall 202. Accordingly, a second distance D2 between the upper surface 221 of the key 219 and the step 216 of the radial wall 202 in the unlocked state is greater than the first distance D1 in the mated state. In the unlocked state, the locking element 246 moves in a radial direction as shown by arrow B as to be at least partially received within the recess 226 of the key 219. As such, the cover 210, which is biased towards the end effector 102 with the spring 244, is no longer locked in the biased position.

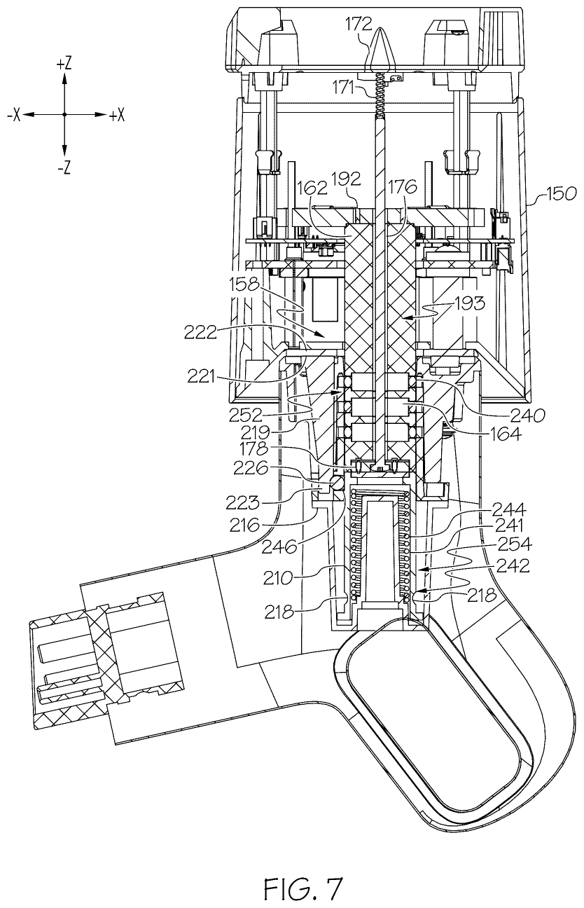

Referring now to FIG. 7, the vehicle charging system 100 in the unlocked state and inserted position is depicted. As described above, in the unlocked state, the locking element 246 of the locking member 220 is at least partially positioned within the recess 226 of the key 219. As such, the cover 210 is able to move from the biased position to the unbiased position. In the inserted position, the extended portion 193 of the plunger 162 extends through the plunger opening 158 in the distal end 156 of the end effector housing 150 and into the receiving cavity 242 of the receiver 112. In the inserted position, electrical contacts 178 extending distal to the screw 176 come into contact with the cover 210. In some embodiments, the electrical contacts 178 come into contact with the plate 211 placed on the cover 210. In embodiments, the electrical contacts 178 may be utilized to indicate communication of the plunger 162 with the receiver 112 such as, for example, with the cover 210.

The cover 210 is pressed in a downward direction by the plunger 162 to be positioned in the unbiased position within the second receiving cavity positon 254. The spring 244 is in a compressed state. With the cover in the unbiased position, the plunger electrical contacts 164 engage the electrical contacts 240 of the receiver 112, creating an electrical connection between the end effector 102 and the receiver 112. This connection allows for current to be delivered to the electric vehicle 10 (FIG. 1).

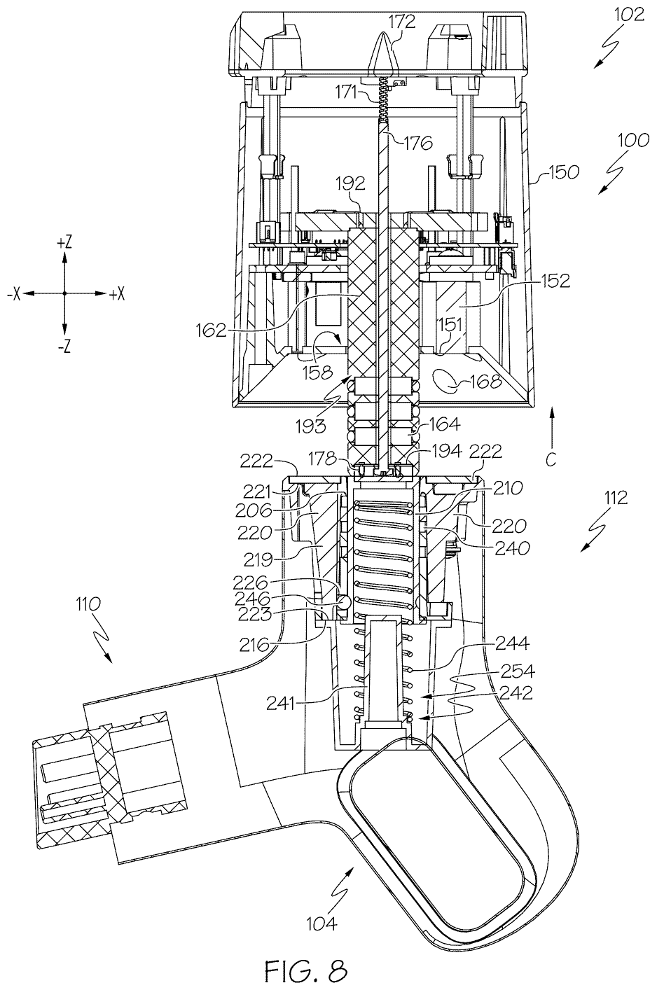

Referring now to FIG. 8, the vehicle charging system 100 in the locked state and ejected position is depicted. In the locked state and ejected position, the key 219 and the electromagnet 152 have disengaged as the electromagnetic 152 is in the inactive state. The end effector 102 separates from the receiver 112. As described above, the key 219 of the locking member 220 is in the locking position wherein the lower surface 223 of the key 219 abuts the step 216 of the radial wall 202. The locking element 246 is positioned within the detent 218 in the side wall 214 of the cover 210. The cover 210 is in the biased position such that the spring 244 biases the cover 210 within the first receiving cavity portion 252 of the receiver 112 in the direction of arrow C. The locking element 246 prevents the cover 210 from moving towards the unbiased position. The plunger 162 remains in the extended position with the extended portion 193 extending through the plunger opening 158 of the distal end 156 of the end effector housing 150.

Referring now to FIG. 9 the control system 108 may be operated in conjunction with the vehicle charging system 100, as well as any of the vehicle charging systems discussed herein. However, for brevity, the control system 108 will only be described with reference to the vehicle charging system 100. The control system 108 may include a controller 1020 and a communication path 1022 communicatively coupling the controller 1020 to the motor 170, the sensor 168, the electromagnets 152, and the charging station 50. The controller 1020 includes a processor 1024 and a non-transitory electronic memory 1026 to which various components are communicatively coupled. In some embodiments, the processor 1024 and the non-transitory electronic memory 1026 and/or the other components are included within a single device. In other embodiments, the processor 1024 and the non-transitory electronic memory 1026 and/or the other components may be distributed among multiple devices that are communicatively coupled. The controller 1020 includes non-transitory electronic memory 1026 that stores a set of machine-readable instructions. The processor 1024 executes the machine-readable instructions stored in the non-transitory electronic memory 1026. The non-transitory electronic memory 1026 may include RAM, ROM, flash memories, hard drives, or any device capable of storing machine-readable instructions such that the machine-readable instructions can be accessed by the processor 1024. Accordingly, the control system 108 described herein may be implemented in any conventional computer programming language, as pre-programmed hardware elements, or as a combination of hardware and software components. The non-transitory electronic memory 1026 may be implemented as one memory module or a plurality of memory modules.

The processor 1024 may be any device capable of executing machine-readable instructions. For example, the processor 1024 may be an integrated circuit, a microchip, a computer, or any other computing device. The non-transitory electronic memory 1026 and the processor 1024 are coupled to the communication path 1022 that provides signal interconnectivity between various components and/or modules of the actuation system. Accordingly, the communication path 1022 may communicatively couple any number of processors with one another, and allow the modules coupled to the communication path 1022 to operate in a distributed computing environment. Specifically, each of the modules may operate as a node that may send and/or receive data. As used herein, the term “communicatively coupled” means that coupled components are capable of exchanging data signals with one another such as, for example, electrical signals via conductive medium, electromagnetic signals via air, optical signals via optical waveguides, and the like.

As schematically depicted in FIG. 9, the communication path 1022 communicatively couples the processor 1024 and the non-transitory electronic memory 1026 of the controller 1020 with a plurality of other components of the control system 108. For example, the control system 108 includes the processor 1024 and the non-transitory electronic memory 1026 communicatively coupled with the motor 170, the electromagnets 152, and the sensor 168. The controller 1020 may be configured to activate the electromagnets 152 upon a detection by the sensor 168. For example, as the end effector 102 approached the receiver, a light sensor senses the receiver 112 and the electromagnets 152 are activated. Further, upon the electromagnets 152 engaging with the key 219, the controller 1020 may actuate the motor 170 to move the plunger 162 in the direction of arrow A.

Now referring to FIG. 10 a flowchart of an example method 950 of operating the vehicle charging system 100 is depicted with respect to the components described herein and illustrated in FIGS. 1-9. The vehicle 10 may be parked in a parking structure using an automated parking system that automatically parks the vehicle 10 in a parking structure. The automated parking system may use a lift that picks up and transports the vehicle 10 to a parking space in the parking structure. When the driver gets out of the vehicle 10 and before the automated parking system transports the vehicle 10 to the parking space, the driver may insert the adapter 104 housing the receiver 112 into the charging port 18. Once the vehicle is transported to a parking space, the method 950 may include, at step 952, the end effector 102 approaching the receiver 112. Upon approach of the end effector 102, the electromagnets 152 are in the inactive state. At step 952, the vehicle charging system 100 is in the locked state and disengaged position as described above.

At step 954, the method 950 may include the end effector 102 mating with the receiver 112. At step 954, the method 950 may include the sensor 168 causing the electromagnets 152 to activate. Specifically, the locating member 166 causes the end effector 102 to position above the receiver 112 and the key 219 of the locking member 220 engages with the electromagnets 152. The engagement of the electromagnets 152 by the locking member 220 causes the plunger 162 to move in the direction of arrow A. In embodiments, the activation of the electromagnets 152 activates the motor 170 to move the plunger 162.

At step 956, the movement of the plunger 162 in the direction of arrow A causes the end effector 102 to unlock the locking member 220 of the receiver 112. At step 956, the vehicle charging system 100 moves into the unlocked state and secured position, as described above. At this step, the plunger 162 applies a force in the direction of arrow A, causing the key 219 to move in the direction of arrow C. As the key 219 moves into the unlocked position, the recess 226 of the key 219 corresponds to the position of the locking element 246. The locking element 246 moves in the direction of arrow B from the detent 218 in the cover 210 to the recess 226 of the key 219, unlocking the cover 210.

At step 958, the plunger 162 extends through the plunger opening 158 of the end effector housing 150 and into the receiving cavity 242 of the receiver 112 and the plunger electrical contacts 164 connect with the receiver electrical contacts 240. At this step, the current may pass from the charging station 50 through the charging cable 160 and into the adapter 104 through the plunger electrical contacts 164 and the receiver electrical contacts 240. Once the electrical current is supplied to the adapter 104, the current may pass to the charging port 18 through connection with the connector 110, and charge the vehicle battery 16.

At step 960, the end effector 102 and plunger 162 may be ejected from the receiver 112 upon a detection of unexpected movement, touch, or other factor to prevent damage to the vehicle charging system 100 or individual. At step 960, upon a detection, the electromagnet 152 deactivates and decouples from the key 219. Upon decoupling, the spring 244 applies a force in the direction of arrow C causing the end effector 102, specifically the plunger 162, to eject from the receiving cavity 242 of the receiver 112. The cover 210 moves into the biased position such that an individual can no longer access the receiver electrical contacts 240.

It should now be understood that embodiments described herein are directed to directed to vehicle charging systems for charging an electric vehicle that includes mechanisms for the protection of both the system and users of the system. In particular, embodiments for charging an electric vehicle include an end effector having a charging cable coupled to a charging station and a receiver connected to an adaptor including a cover engageable between a biased and an unbiased position prevent an individual from accessing live electrical contacts during the operation of the vehicle charging system. Embodiments of the charging system include a locking member that is configured to cause the end effector to rapidly eject in a case of unexpected movement.

While particular embodiments have been illustrated and described herein, it should be understood that various other changes and modifications may be made without departing from the spirit and scope of the claimed subject matter. Moreover, although various aspects of the claimed subject matter have been described herein, such aspects need not be utilized in combination. It is therefore intended that the appended claims cover all such changes and modifications that are within the scope of the claimed subject matter.

What is claimed is:

1. An end effector comprising:
an end effector housing including a proximal end and a distal end opposite the proximal end, a plunger opening formed in the distal end;
an electromagnet fixed to the end effector housing and provided at the opening of the distal end of the end effector housing, the electromagnet operable between an active state and an inactive state; and
a plunger coupled to the end effector housing and movable through the opening between a retracted position and an extended position relative to the end effector housing, a plunger electrical contact provided on an outer surface of the plunger.

2. The end effector of claim 1, further comprising a motor for moving the plunger between the retracted position and the extended position.

3. The end effector of claim 1, further comprising a sensor configured to detect the end effector engaging a receiver, wherein the electromagnet is operated in the active state in response to the sensor detecting the end effector engages the receiver.

4. The end effector of claim 1, wherein the end effector housing comprises an outer surface and an inner surface extending from the outer surface at the distal end of the end effector housing and defining the opening, the inner surface tapering toward the proximal end of the end effector housing.

5. The end effector of claim 2, wherein, in response to the electromagnet being operated in the active state,
the motor is configured to move the plunger from the retracted position to the extended position.

6. The end effector of claim 1, further comprising a charging cable extending from the proximal end of the end effector housing and transferring electrical current to the plunger electrical contact of the plunger.

7. A receiver comprising:
a receiver housing comprising a radial wall defining a receiving cavity, a receiver opening formed in the receiver housing;
a cover positioned within the receiving cavity and movable between a biased position and an unbiased position, a detent formed in a side wall of the cover;
a locking member positioned between the radial wall and the side wall of the cover, the locking member comprising:
a key having an inner surface facing the cover and a recess formed in the inner surface, the key movable between a locking position and an unlocking position; and
a locking element movable radially between the detent formed in the cover and the recess formed in the key; and
a receiving electrical contact provided within the receiving cavity;
a spring positioned within the receiving cavity and configured to bias the cover towards the biased position.

8. The receiver of claim 7, wherein the locking member includes a plurality of keys spaced apart from one another and arranged circumferentially about the cover.

9. The receiver of claim 7, further comprising a connector configured to engage with a charging port of a vehicle, wherein the receiver is electrically coupled to the charging port of the vehicle by the connector.

10. The receiver of claim 7, wherein the locking element is a ball bearing.

11. The receiver of claim 7, further comprising a biasing member for biasing the key toward the locking position from the unlocking position.

12. The receiver of claim 7, wherein
the receiving cavity includes first receiving cavity portion and second receiving cavity portion,
the locking member is provided within the first receiving cavity portion,
the second receiving cavity portion has a reduced diameter relative to the first receiving cavity portion to define a step, the key abuts against the step when in the locking position, and
the cover is provided within the first receiving cavity portion when in the biased position, and within the second receiving cavity portion when in the unbiased position.

13. A charging system comprising:
an end effector comprising:
an end effector housing; and
a plunger coupled to the end effector housing and movable between a retracted position and an extended position relative to the end effector housing;
a receiver comprising:
a receiver housing defining a receiving cavity,
a cover positioned within the receiving cavity and movable between a biased position and an unbiased position, a detent formed in a side wall of the cover;
a locking member positioned within the receiving cavity, the locking member comprising:
a key having an inner surface facing the cover and a recess formed in the inner surface, the key movable between a locking position and an unlocking position; and
a locking element movable radially between the detent formed in the cover and the recess formed in the key; and
a spring positioned within the receiving cavity and configured to bias the cover towards the biased position.

14. The system of claim 13, wherein
the end effector further comprises an electromagnet fixed to the end effector housing,
the key includes an upper surface configured to couple to the electromagnet in an active state.

15. The system of claim 13, wherein the end effector further comprises a locating member, the locating member comprises one or more surfaces that extend around the receiver when the plunger is positioned within the receiving cavity of the receiver.

16. The system of claim 13, wherein
the receiving cavity includes first receiving cavity portion and second receiving cavity portion,
the locking member is provided within the first receiving cavity portion,
the second receiving cavity portion has a reduced diameter relative to the first receiving cavity portion to define a step, the key abuts against the step when in the locking position, and
the cover is provided within the first receiving cavity portion when in the biased position, and within the second receiving cavity portion when in the unbiased position.

17. The system claim 13, further comprising a motor for moving the plunger between the retracted position and the extended position, wherein
the motor extends the plunger into the receiving cavity of the receiver upon coupling of the end effector and the receiver.

18. The system of claim 13, wherein the receiver is operable between a locked state and a unlocked state, the plunger configured to extend within the receiving cavity in the unlocked state, wherein
in the locked state, the cover is in the biased position, the locking element is received within the detent of the cover, and the key is in the locking position, and
in the unlocked state, the cover is in the unbiased position, the locking element is received within the recess of the key, and the key is in the unlocking position.

19. The system of claim 14, wherein the end effector further comprises a sensor configured to detect the end effector engaging the receiver, wherein the electromagnet is controlled into the active state in response to the sensor detecting the end effector engages the receiver.

20. The system of claim 13, wherein a distance between a proximal end of the plunger and an upper surface of the end effector housing when the plunger is in the retracted position is less than when the plunger is in the extended position.
